(19) United States
(12) Patent Application Publication
(10) Pub. No.: US 2023/0188670 A1
(43) Pub. Date: Jun. 15, 2023

(54) SYSTEM AND METHOD FOR GENERATION OF MEDIA CONTENT WITH A MOBILE AUDITION APPARATUS

(71) Applicant: Sean Overbeeke, Franklin, TN (US)

(72) Inventor: Sean Overbeeke, Franklin, TN (US)

(21) Appl. No.: 18/076,953

(22) Filed: Dec. 7, 2022

Related U.S. Application Data
(60) Provisional application No. 63/289,050, filed on Dec. 13, 2021.

(51) Int. Cl. H04N 5/28; H04N 23/661; H04N 23/51; H04N 5/77; H04N 21/475; H04N 21/2187; H04R 1/04; H04R 1/08; H04R 3/00; H04N 21/8547; H04R 1/02; G11B 27/34

(52) U.S. Cl. CPC H04N 5/28; H04N 23/661; H04N 23/51; H04N 5/77; H04N 21/4758; H04N 21/2187; H04R 1/04; H04R 1/08; H04R 3/00; H04N 21/8547; H04R 1/028; G11B 27/34

(57) ABSTRACT

Systems, methods, and apparatus for generation of media content associated with at least one code using an audition apparatus as described herein. The audition apparatus is connected to a remote platform over a network, with the remote platform providing for command and control of equipment included in the audition apparatus. Media content produced in each audition apparatus is timestamped, providing for synchronization of content received from different media capture devices of the same audition apparatus and content received from different media capture devices across different audition apparatuses.

### CROSS REFERENCES TO RELATED APPLICATIONS

This application is related to and claims priority from the following U.S. patents and patent applications. This application claims priority to and the benefit of U.S. Provisional Application No. 63/289,050, filed Dec. 13, 2021, which is incorporated herein by reference in its entirety.

### BACKGROUND OF THE INVENTION

### 1. Field of the Invention

The present invention relates to generation of media content, and more specifically to a mobile audition apparatus and a remote software platform providing command and control of the mobile audition apparatus over a network.

### 2. Description of the Prior Art

It is generally known in the prior art to provide audition & recording spaces for artists and content creators such as musicians, actors, interviewers, and others.

Prior art patent documents include the following:

US Patent Publication No. 2021/0314521 for Audio and video recording and streaming in a three-computer booth by inventor Olshansky, filed Mar. 25, 2021 and published Oct. 7, 2021, is directed to a system and method for recording audio and video of an individual within a kiosk on separate audio and video computers that are locally connected to the kiosk. Instructions are provided to the individual through a locally connected controller computer. A remote user computer requests recorded data from the kiosk. The controller computer prompts the audio and video computers to separately stream audio and video to the remote user computer. The controller computer divides the audio and video data into time segments, and then presents different versions of the session to different users, with each different version comprising a different set of time segments. A central system server provides searching capabilities to the user computer to search and request data from a plurality of remotely located kiosks, each having separate controller, audio, and video computers.

US Patent Publication No. 2018/0054641 for Method of livestreaming an audiovisual audition by inventors Hall, et al., filed Aug. 18, 2016 and published Feb. 22, 2018, is directed to a method of livestreaming an audiovisual audition which allows a candidate to livestream an audiovisual audition to a talent agency, talent competition, or similar entity. A plurality of computerized kiosks is utilized to capture and livestream the audiovisual audition. The candidate is able to enter personal information to generate a candidate profile on at least one remote server. Audiovisual audition data for the candidate profile is retrieved and livestreamed to an audience a plurality of personal computing (PC) devices through a destination web portal. A voting process is executed to allow the audience to vote for the candidate profile with the plurality of PC devices. An aggregated vote count is calculated by subtracting a plurality of negative votes from a plurality of positive votes to rank the candidate profile amongst other candidate profiles from a particular region or state.

US Patent Publication No. 2011/0229108 for Method and apparatus to conduct a contest via remote booth by providing contestant with ownership of and control of confidentiality of recorded performance by inventors Ryckman, et al., filed Apr. 15, 2011 and published Sep. 22, 2011, is directed to apparatus to conduct a contest in which recorded performances of different individuals are reviewed to select a winner. The apparatus comprises at least one recording booth. The booth includes recording equipment comprising at least one camera for photographing the video portion of at least one individual's performance and generating video signals, at least one microphone for sensing the audio portion of the individual's performance and generating audio signals, lighting; performance apparatus to record video and audio signals generated by the camera and microphone and generate a recorded performance by the individual, and, a display viewable by the individual indicating the individual's ownership of the recorded performance and the control by the individual of the confidentiality of the performance.

US Patent Publication No. 2009/0118849 for Automated vending-type studio recording facility by inventors Dery, et al., filed Nov. 1, 2008 and published May 7, 2009, is directed to an improved portable automated recording facility and method of use thereof. In particular, this invention relates to a self-contained, self-operated and fully automated audio/video recording and production system. The preferred embodiment of this invention comprises an external shell having sound-dampening material to dampen sound from the entering or exiting the facility. The facility contains a recording chamber including a removable recording equipment module having multi-track recording equipment and a disk media recording device connected to a user system interface. The facility is preferably connected to an external network such as the Internet and has external media connectors for uploading and downloading recordings to or from users. A plurality of facilities can be networked together at a central server so they can be, inter alia, monitored for maintenance data, receive software upgrades, access media in a database, or be used to remotely conduct a performance contest.

US Patent Publication No. 2007/0250879 for Method and apparatus to conduct a contest utilizing a booth that provides a control card both to activate a contest recording and to define contest rules by inventors Ryckman, et al., filed Sep. 22, 2006 and published Oct. 25, 2007, is directed to a method for conducting a contest in which recorded performances of different individuals are reviewed to select a winner. The method includes the steps of providing a plurality of recording booths each including recording equipment comprising at least one camera for photographing the video portion of an individual's performance and generating video signals; at least one microphone for sensing the audio portion of an individual's performance and generating audio signals; lighting; performance apparatus to record video and audio signals generated by said camera and microphone and to balance the volume of the individual's voice with any accompaniment music. The recording equipment in one of the booths produces a recorded performance having recording characteristics generally equivalent to a recorded performance produced in each of the others of the recording booths.

US Patent Publication No. 2007/0250878 for Interactive system for conducting contest by inventors Ryckman, et al., filed Sep. 22, 2006 and published Oct. 25, 2007, is directed to an apparatus and method to enable video communication through a studio that is placed in a public location whereby a studio user records a performance, presentation, or an interview. In one embodiment, information seekers with special interest may view interviews or presentations recorded by studio users pertaining to subject matter relevant to that special interest. In another embodiment, a performance is recorded and uploaded to the Internet where the general public locates and views the performance. In an alternate embodiment, the performance is rated.

US Patent Publication No. 2007/0250374 for Method and apparatus to conduct contest under equivalent recording conditions by inventors Ryckman, et al., filed Sep. 22, 2006 and published Oct. 25, 2007, is directed to a method for conducting a contest in which recorded performances of different individuals are reviewed to select a winner. The method includes the steps of providing a plurality of recording booths each including recording equipment comprising at least one camera for photographing the video portion of an individual's performance and generating video signals; at least one microphone for sensing the audio portion of an individual's performance and generating audio signals; lighting; performance apparatus to record video and audio signals generated by said camera and microphone and to balance the volume of the individual's voice with any accompaniment music. The recording equipment in one of the booths produces a recorded performance having recording characteristics generally equivalent to a recorded performance produced in each of the others of the recording booths.

US Patent Publication No. 2007/0238498 for Method and apparatus to conduct contest at multiple remote locations by inventors Ryckman, et al., filed Sep. 22, 2006 and published Oct. 11, 2007, is directed to a system to conduct a contest. The system defines a number of contest winners to be selected in the contest, defines a reward for each contest winner, defines a deadline date for entering the contest, defines limitations on who can enter the contest, defines a performance category to be used in the contest, provides a plurality of separate remote booths to produce in each of the booths a recorded personal performance by an individual in said both in said performance category, transmits from each of the booths to a selected location by the deadline recorded personal performances in the performance category, selects winners from the transmitted recorded personal performances, and, awards a reward to each of the winners.

US Patent Publication No. 2007/0237496 for Method and apparatus to conduct a contest via remote booth by providing contestant with ownership of and control of confidentiality of recorded performance by inventors Ryckman, et al., filed Nov. 22, 2006 and published Oct. 11, 2007, is directed to apparatus to conduct a contest in which recorded performances of different individuals are reviewed to select a winner. The apparatus comprises at least one recording booth. The booth includes recording equipment comprising at least one camera for photographing the video portion of at least one individual's performance and generating video signals, at least one microphone for sensing the audio portion of the individual's performance and generating audio signals, lighting; performance apparatus to record video and audio signals generated by the camera and microphone and generate a recorded performance by the individual, and, a display viewable by the individual indicating the individual's ownership of the recorded performance and the control by the individual of the confidentiality of the performance.

US Patent Publication No. 2007/0098368 for Mobile recording studio system by inventors Carley, et al., filed May 23, 2006 and published May 3, 2007, is directed to a stand-alone performance recording system includes an enclosure or performance area adapted to be moved from a first location to a second location, and temporarily, semi-permanently or permanently set up at the second location for the purpose of recording the audio and/or visual aspects of an event performed within the enclosure. Digital audio and video recording are performed within the enclosure. A controlled environment is provided within the enclosure, and the recording system includes features that allow for the superposing and/or editing of multiple live and prerecorded audio and/or video inputs provided within the stand-alone enclosure during an event performed within the enclosure at whatever location is desired.

U.S. Pat. No. 11,159,748 for Studio in a box by inventor Cohen, filed Jul. 14, 2020 and issued Oct. 26, 2021, is directed to a studio in a box which includes displays arranged along the interior of the studio. A camera and microphone is arranged in the studio to capture a multimedia production, using content shown on the displays as background for the production. Other aspects are described.

KR Patent Publication No. 2000/0054662 for Audition and its management method through internet and song studio by inventor [symbol] , et. al, is directed to an audition through internet and karaoke room and the management method thereof so that cost can be reduced and effect can be enhanced by using a popularized space. An audition through internet and karaoke room and the management method thereof includes several steps. In a step, on the basis of the audition relating information, song, play, dance, model and gag are played and recorded by an audition device. In a step, a user can see or listen the recorded information. In a step, the recorded contents by the user is changed into digital signals, as a moving picture file or a music file by the audition device. The changed files are received by the server of an internet web site manager. The received content broadcasts through internet network and is then examined by general netizens, managers, and specialized examiners. As a result of the examination, the manager rewards the user and the karaoke room relating to the user.

### SUMMARY OF THE INVENTION

The present invention relates to an audition apparatus accessible via at least one code, with the audition apparatus being connected to a remote platform providing for command and control of the audition apparatus as well as real-time or near real-time editing and synchronization of audio and video content.

It is an object of this invention to offer a secure recording environment for content creators, such as performers and contestants, and real-time or near real-time editing & synchronization of audio and video content generated in the recording environment on a remote platform.

In one embodiment, the present invention includes a system for recording multimedia content including an apparatus for recording the multimedia content including a housing, a microphone, a camera, one or more power sources for providing power to the camera and/or the microphone, and an identity authentication device, and a platform device including a processor, wherein the housing includes the microphone and the camera within the housing, wherein the housing includes at least one wall and a door, wherein the housing is approximately eight feet in width or approximately eight feet in diameter, wherein the apparatus is constructed and configured for communication with the platform device via at least one local device including at least a processor, wherein the identity authentication device is configured to unlock the apparatus upon verifying that a user or a user device is authorized to access the apparatus, wherein the microphone and the camera are configured to record audio content and video content, wherein the audio content and the video content is timestamped with timestamps indicating the time that the audio content and the video content was recorded, and wherein the audio content and the video content and the timestamps are transmitted to the platform device.

In another embodiment, the present invention includes a system for recording multimedia content including an apparatus for recording the multimedia content including a housing, a microphone, a camera, one or more power sources for providing power to the camera and/or the microphone, and an identity verification device, and a platform device including a processor, wherein the apparatus is constructed and configured for communication with the platform device, wherein the identity authentication device is configured to unlock the apparatus upon verifying that a user or a user device is authorized to access the apparatus, wherein the microphone and the camera are configured to record audio content and video content, wherein the audio content and the video content is configured to be streamed to at least one display device including a display and a speaker in real time or near real time, and wherein the audio content and/or the video content is configured to be automatically edited by the platform device in real time or near real time, wherein the automatic editing of the audio content and/or the video content includes adjustments to hue, saturation, brightness, and/or contrast, adjustments to gain and/or tone, normalization, equalization, amplification, compression, application of one or more filters, and/or noise removal.

In yet another embodiment, the present invention includes a system for recording multimedia content including an apparatus for recording the multimedia content including a housing, a microphone, a camera, and one or more power sources for providing power to the camera and/or the microphone, and a platform device including a processor, wherein the apparatus is constructed and configured for communication with the platform device, wherein the microphone and the camera are configured to record audio content and video content, and wherein additional audio content and/or additional video content is configured to be integrated with the audio content and the video content in real time or near real time, and wherein the integrated audio content and the integrated video content is configured to be played on a display device including a display and a speaker in real time or near real time.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a schematic diagram of the media generation system according to one embodiment of the present invention.

FIG. 2 illustrates a perspective view of the housing of an audition apparatus according to one embodiment of the present invention.

FIG. 3 illustrates a perspective, transparent view of the inside of the audition apparatus of FIG. 2 according to one embodiment of the present invention.

FIG. 4 is a schematic diagram of an embodiment illustrating a computer system according to one embodiment of the present invention.

### DETAILED DESCRIPTION

The present invention is generally directed to an audition apparatus providing for recording of media content, with the audition apparatus being connected over a wireless network to a remote platform providing for command and control of the audition apparatus and real-time or near real-time editing and synchronization of time stamped media content recorded in the audition apparatus to enable production of edited media content.

In one embodiment, the present invention includes a system for recording multimedia content including an apparatus for recording the multimedia content including a housing, a microphone, a camera, one or more power sources for providing power to the camera and/or the microphone, and an identity authentication device, and a platform device including a processor, wherein the housing includes the microphone and the camera within the housing, wherein the housing includes at least one wall and a door, wherein the housing is approximately eight feet in width or approximately eight feet in diameter, wherein the apparatus is constructed and configured for communication with the platform device via at least one local device including at least a processor, wherein the identity authentication device is configured to unlock the apparatus upon verifying that a user or a user device is authorized to access the apparatus, wherein the microphone and the camera are configured to record audio content and video content, wherein the audio content and the video content is timestamped with timestamps indicating the time that the audio content and the video content was recorded, and wherein the audio content and the video content and the timestamps are transmitted to the platform device.

In another embodiment, the present invention includes a system for recording multimedia content including an apparatus for recording the multimedia content including a housing, a microphone, a camera, one or more power sources for providing power to the camera and/or the microphone, and an identity verification device, and a platform device including a processor, wherein the apparatus is constructed and configured for communication with the platform device, wherein the identity authentication device is configured to unlock the apparatus upon verifying that a user or a user device is authorized to access the apparatus, wherein the microphone and the camera are configured to record audio content and video content, wherein the audio content and the video content is configured to be streamed to at least one display device including a display and a speaker in real time or near real time, and wherein the audio content and/or the video content is configured to be automatically edited by the platform device in real time or near real time, wherein the automatic editing of the audio content and/or the video content includes adjustments to hue, saturation, brightness, and/or contrast, adjustments to gain and/or tone, normalization, equalization, amplification, compression, application of one or more filters, and/or noise removal.

In yet another embodiment, the present invention includes a system for recording multimedia content including an apparatus for recording the multimedia content including a housing, a microphone, a camera, and one or more power sources for providing power to the camera and/or the microphone, and a platform device including a processor, wherein the apparatus is constructed and configured for communication with the platform device, wherein the microphone and the camera are configured to record audio content and video content, and wherein additional audio content and/or additional video content is configured to be integrated with the audio content and the video content in real time or near real time, and wherein the integrated audio content and the integrated video content is configured to be played on a display device including a display and a speaker in real time or near real time.

Music recording studios and video studios have traditionally been centralized, with all equipment in one location, which is inconvenient for performers or artists who are located remotely from these centralized locations. People who hope to have a career in a certain music genre, such as country music, have traditionally had to travel to country music hubs such as Nashville to increase their chance of being recognized and signed to a record label or engaged to perform concerts. Similarly, people who wish to audition for movies have traditionally moved to areas known for movie recording and production, such as Hollywood. While certain television shows such as AMERICAN IDOL have provided the opportunity for such hopefuls to showcase their talent, these television shows still require performers to travel to a specific location to audition and perform. Additionally, concert venues are centralized locations, and audiences have traditionally had to travel to such a location to see a performer perform a piece of media live.

The increased connectivity of wireless devices provides the ability for increased interactions between remote performers and audiences, as well as other remote performers. Performers and artists from different geographic locations have had the opportunity to collaborate remotely via networked devices in real time or near real time, accelerating advancements in music and entertainment. Situations such as the COVID-19 pandemic have also demonstrated the need for remote interaction and collaboration to reduce the risk of spreading infectious disease, especially for those in at risk population segments.

Current issues with remote live performances and remote recording include the lack of the availability of quality equipment and professional configuration of this equipment in different locations, as well as the lack of professional editing services available to participants, and the lack of assessment such as a score or a rating of a performance. Additionally, while many participants are musically talented or talented at acting or speaking, these participants do not typically understand how to operate and set parameters for recording equipment, and typically do not have access to professional recording equipment. Products and services such as ZOOM provide for remote recording and remote performances, but errors by users such as application of filters, including the infamous “I'm not a cat” incident create frustration for users and audiences alike. Audio and video equipment also typically has a variety of settings which are operable to be adjusted to produce the best quality and most impactful audio and video under different recording scenarios and according to different artist and presenter styles and genres. While recording studios exist, the recordings are typically recorded locally and neither performers nor audiences have access to the raw or edited audio and/or video in real time or near real time. Accordingly, there is a need for an audition apparatus providing access to predetermined individuals for recording high quality audio and/or video in decentralized locations. Additionally, there is a need for remote control of the audition apparatus, including remote control for settings of the equipment and remote control of devices recording audio and/or video. There is also a need for real-time or near real-time synchronization of audio and/or video tracks recorded at the audition apparatus or at multiple audition apparatuses, and providing real-time or near real-time editing of audio and/or video tracks.

None of the prior art discloses an audition apparatus which is operable to be unlocked by an identity verification device receiving a unique code from a contestant or performer device, with a remote platform operable for command and control of the audition apparatus, including unlocking of the audition apparatus upon the identity verification device receiving the unique code, and real-time or near real-time activation and deactivation of the equipment in the audition apparatus. Further, none of the prior art discloses real-time or near real-time editing of video and audio content from an audition apparatus or multiple audition apparatuses for broadcast or later transmission, communication between audition apparatuses to enable performance of one or more media pieces by multiple performers located remotely from each other, and automated scoring of media content by a scoring module including an artificial intelligence algorithm.

Referring now to the drawings in general, the illustrations are for the purpose of describing one or more preferred embodiments of the invention and are not intended to limit the invention thereto.

The present invention provides systems, methods, and at least one apparatus for generation of media content associated with at least one code using the at least one audition apparatus. The at least one audition apparatus is constructed and configured to provide a mobile housing enclosing equipment for audio and/or video capture of a user performing musical, visual, or other artistic works, which are inputs to the platform. In one embodiment of the present invention, the mobile housing provides an entrance for accessing the enclosed equipment, wherein proximity access into the housing via the entrance requires at least one code generated by a platform for managing the system. Preferably, the platform includes at least one server computer, cloud computing platform, edge computing device, or other processor coupled with memory and data storage capability. The platform computing functions are remotely positioned from the mobile housing, with network-based communication for messaging, including but not limited to command and control messaging, alerts, notifications, and data transfer from the media capture, preferably including audio and/or video capture, associated with each of the at least one code.

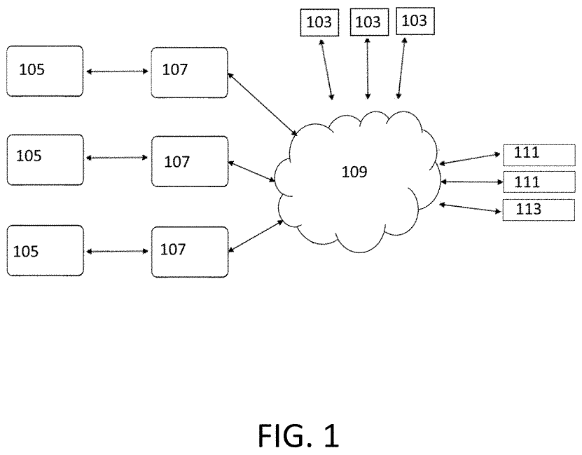

FIG. 1 illustrates a schematic diagram of the media generation system according to one embodiment of the present invention. A plurality of user devices 103 associated with users of the audition apparatuses are in network communication with the platform 109 of the present invention. Each of the user devices 103 includes at least a processor and a memory. Additionally, a plurality of identity verification devices 105 associated with a plurality of audition apparatuses are in network communication with a plurality of computing devices 107 associated with the audition apparatuses. In one embodiment, the local computing devices 107 include an edge device, a computer such as a desktop computer or laptop computer including a processor and a memory, or any other device associated with the audition apparatus. The plurality of computing devices 107 are operable to be any computing device referenced herein which is enclosed within the audition apparatus or which is associated with the audition apparatus Advantageously, a computing device 107 controls the equipment in the audition apparatus based on remote command inputs received by the platform 109. Alternatively, computing devices 107 are not in network communication with the identity verification devices 105, and the identity verification devices 105 are in direct wireless communication with the platform 109 of the present invention. The platform 109 is in network communication with viewer devices 111 which are viewing a performance in the audition apparatus and at least one judge device 113 which receives ratings regarding a performance associated with the audition apparatus.

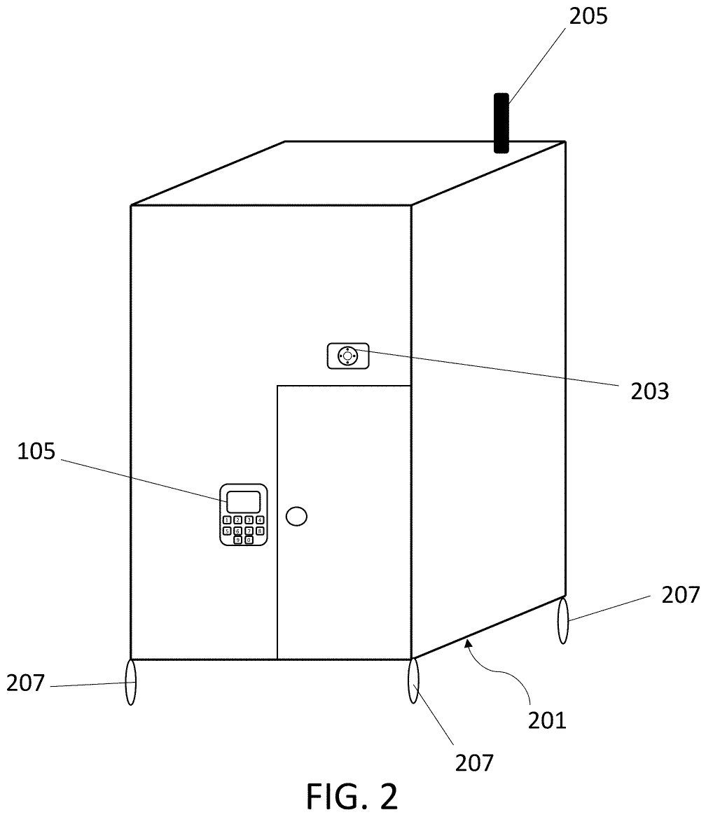

FIG. 2 illustrates a perspective view of the housing 201 of an audition apparatus according to one embodiment of the present invention. The housing 201 of the audition apparatus includes the identity verification device 105, at least one camera 203, an antenna 205, and wheels 207. The housing 201 is preferably soundproof or sound-barrier insulated to reduce or eliminate external noise from entering the audition apparatus. Additionally, the housing 201 preferably includes soundproof, sound-barrier, or sound enhancing components on the interior of the housing 201, such as acoustic panels, diffusers, reflection filters, and/or bass traps. The antenna 205 of the audition apparatus provides for a computing device of the audition apparatus to communicate with other devices and to send and receive data over a network. Preferably, the computing device is connected to the antenna 205 wirelessly or via one or more wired connections, such as cables.

In one embodiment, the housing 201 is about eight feet in height, about eight feet in width, and about eight feet in length. Advantageously, these dimensions provide for the audition apparatus to be portable and movable. In one embodiment, the housing is mobile and includes a plurality of wheels 207 providing for mobility. Preferably, the wheels 207 include locks only operable to be unlocked by an administrator device, or mechanical locks unlockable via a key, a code, or any other method known in the art. Locking of the wheels prevents theft or movement of the audition apparatus. The wheels 207 enable the housing 201 to be physically pushed or pulled by a person or group of people. Additionally, an audition apparatus or audition box that is about eight feet in height, about eight feet in width, and about eight feet in length is operable to be loaded onto a trailer and transported via a motor vehicle on roads, or even loaded onto ships for transport across bodies of water. Additionally, this compact size enables the audition apparatus to be transported via cargo or freight aircraft. However, the housing is operable to be any dimensions known in the art depending on a variety of factors, including a desired occupancy capacity for the audition apparatus, sizes of instruments played in the audition apparatus, and storage space within the audition apparatus.

The housing 201 is preferably weatherized and/or ruggedized to provide insulation and protection from weather elements, noise, temperature and humidity external to the housing 201, etc. Examples of weather resistant or ruggedized materials include weather resistive barriers (WRBs), structural insulated panels, vacuum insulation panels, thermoplastics such as polycarbonate, or any other water-resistant or waterproof material able to withstand hot temperatures (up to 130 degrees Fahrenheit), cold temperatures (down to negative 30 degrees Fahrenheit), and extreme weather such as high winds, hail, ice, and snow. Preferably the housing 201 of the audition apparatus provides an air, water, thermal, and vapor barrier. In one embodiment, the audition apparatus includes a mini split heating ventilation, and air conditioning (HVAC) unit to cool or heat the interior of the audition apparatus as needed. The housing is equipped with communications systems providing for wireless communication of the data captured from the audio and/or video capture equipment to the platform for processing. The housing 201 further includes power supply and/or is connectable to a power supply for the functioning of the equipment and/or HVAC internal air management. In one embodiment, the power supply includes a battery connected to a solar panel. Alternatively, the power supply is provided through an electric power grid or a microgrid. In yet another embodiment, power is provided by biofuels or the like. In one embodiment, the housing 201 is constructed and configured in dimensions that provide for at least one person to be fully enclosed therein, with reasonable space for movement, including use of at least one musical instrument. In another embodiment, the housing 201 internal dimensions provide for at least 10 persons and corresponding instruments to be fully enclosed therein. In one embodiment, the interior of the audition apparatus is configured to receive large instruments such as drum sets, harps, or tubas. Each audition apparatus includes a predetermined set of instruments in one embodiment, such as one or more guitars, one or more bass guitars, and/or one or more drum sets.

The housing 201 further includes external video capture via at least one camera 203 to automatically record audio and/or video of the at least one user approaching and accessing the housing, and automatically transmits this audio and/or video to the platform. Audio and/or video capture is enabled by communication of location data of a device associated with a performer or contestant from the device associated with the performer or contestant to a local computing device associated with the audition apparatus, which commands an external video and/or audio device to capture the external audio and/or video of the at least one user. Additionally or alternatively, the external audio and/or video components include proximity sensors which provide for activation of recording external audio or video of the audition apparatus.

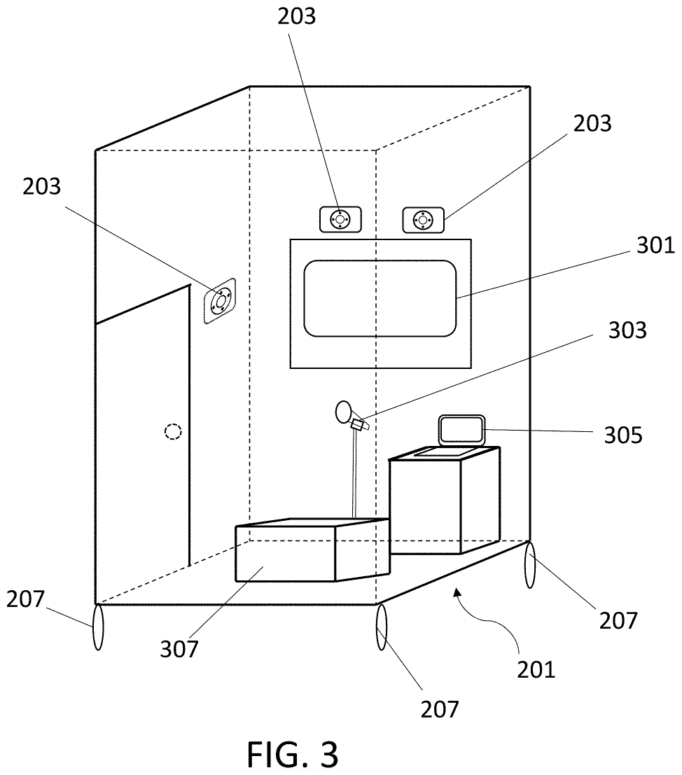

FIG. 3 illustrates a perspective, transparent view of the inside of the audition apparatus of FIG. 2 according to one embodiment of the present invention. The inside of the audition apparatus includes one or more cameras 203, a display 301, a microphone 303, a local computing device 305, and a seat or a stand 307. The inside of the audition apparatus also includes other audio and/or video equipment, including but not limited to the audio and/or video equipment discussed herein.

In another embodiment, audition apparatuses include modular pieces such as modular walls operable to allow for multiple audition apparatuses to be joined together to accommodate additional performers. In one embodiment, the structural components of the audition apparatuses include structural building panels such as those described in U.S. Pat. Nos. 8,539,732, 8,869,492, 8,590,264, and 10,787,803, each of which is incorporated herein by reference in its entirety.

As discussed with respect to FIG. 2, at least one code is operable to be received by the identity verification device to provide access to the audition apparatus. The at least one code which provides access to the audition apparatus is operable to provide access to only one specific audition apparatus associated with a specific identity verification device, a plurality of audition apparatuses associated with multiple identity verification devices within a predetermined geographic location, or any audition apparatus registered with the platform of the present invention. The at least one code is generated by the platform after receiving a request for access to the mobile housing from at least one portable computing device associated with the at least one user, which includes, by way of example and not limitation, a smart phone, computer, tablet computer, wearable computing devices such as a smart watch, and functional equivalents thereof. The at least one code includes, by way of example and not limitation, a numeric code, an image, a quick response (QR) code, a bar code, or any other visual code readable by a sensor known in the art. In one embodiment, the image or code includes a watermark detectable by an identity verification device attached or connected to the mobile housing. The watermark is operable to be encoded in the code such that it is not visible to the human eye in visible light, but requires activation via a light source emitting waves outside of the visible spectrum or activation via another activation method provided by the identity verification device. The at least one code is sent over the network by the platform to the at least one portable computing device associated with the at least one user.

The at least one code provides for proximity access to the apparatus housing entrance when entered as an input to an identity verification device connected to a door of the housing. The identity verification device includes at least a processor, a sensor operable to read the code or a camera operable to read the code, and a wireless communications component operable to communicate with the platform and/or a local computing device associated with the audition apparatus. In an exemplary use case, the identity verification device is a tablet which includes a processor, a memory, a wireless communications interface, and an integrated camera operable to capture at least one photograph and/or video and audio data. The integrated camera of the tablet captures one or more photos and/or a video of a contestant or a potential contestant as the contestant approaches the audition apparatus. The tablet also includes at least one data input mechanism, including but not limited to a keyboard, a touch screen including a graphical user interface (GUI) with one or more virtual input mechanisms such as keys, buttons, sliders, etc., an interface operable to receive a signature via a stylus or a contestant's finger, an attached stylus, and a microphone. The tablet is operable to receive information from the contestant or potential contestant including a release and a signature, and is operable to associate this information with one or more photographs, videos, and/or audio of the contestant. The tablet is operable to send this information along with the one or more photographs, videos, and/or audio of the contestant to the platform, with the platform storing the information and the one or more photographs, videos, and/or audio with the contestant or potential contestant along with a unique code to identify the contestant or potential contestant and/or a recording session for the contestant or the potential contestant, and to further associate this information, the one or more photographs, videos, and/or audio with a unique code which identifies the contestant and a specific recording session within the platform. Once the tablet receives the information from the potential contestant or the contestant including a release or other information sufficient to enable the potential contestant or the contestant to use the audition apparatus, a code to unlock the door is generated by the platform. This code is operable to be any code described herein, including the unique code associated with a contestant and/or a session of a contestant. In one embodiment, the code to unlock the door is sent to a mobile device of the user and the tablet or another identity verification device is operable to read the code from the mobile device of the user. In another embodiment, the tablet displays the code for the door and the contestant enters the code on a lock mechanism on the door, such as an alphanumeric keypad on the door. In yet another embodiment, the tablet sends a command which unlocks the door, thereby granting access to the contestant. In an alternative embodiment, the identity verification device includes, by way of example a KISI device. The identity verification device sends a notification to a remote device associated with the platform indicating that a user account or user device has unlocked the audition apparatus once the audition apparatus is unlocked.

Secondary authentication of a user device is utilized in one embodiment, where upon an identification of the at least one code by the identity verification device causes a communication, such as an email, a text message, or a phone call, to be sent to a user device from the platform, with action required from the user device to confirm the identity of the user requesting access to the at least one audition apparatus. Such action includes a response to the communication from the user device to the platform. In another embodiment, secondary authentication is accomplished via proximity authentication of the device with the audition apparatus via any method of determining a location of a device known in the art, such as geofencing, cellular triangulation, global positioning system (GPS), or any other method of determining location described herein. Alternatively, access to the mobile housing is provided via wireless communication between the user device and a wireless network component of the mobile housing. Examples of such communication include BLUETOOTH LOW ENERGY communication, radio frequency (RF) communication, or infrared (IR) communication.

In an exemplary embodiment, a start button in the interior of the audition apparatus is operable to activate recording of the contestant. The start button is operable to be a virtual start button located on a local computing device within the audition apparatus, or is operable to be a physical button within the audition apparatus. In an alternative embodiment, recording of media content such as audio or video content is initiated by a voice command recognized by a local computing device or the platform, such as “start recording”. In an alternative embodiment, upon receiving the code from the platform, the identity verification device also preferably sends a notification to the local computing device and/or the platform to enable recording of media content, such as audio and/or video content, by the equipment within the audition apparatus. In one embodiment, the at least one code also provides for automatic activation of the audio and/or video capture equipment within the audition apparatus for a predetermined time period. The at least one code is further associated with a corresponding identifier of the at least one user, a geolocation of the apparatus housing, and a date and a time for which the at least one code will function to provide for proximity access and equipment activation within the housing. Each session is preferably identified with a unique code, such that there are no duplicate codes.

Upon activation of the start button or another alternative command received by the local computing device or the platform, cameras and microphones in the interior of the audition apparatus begin live streaming and recording, and a timer is activated. In one embodiment, the start button is wirelessly connected to the cameras, microphones, and timer. In another embodiment, the start button is in wireless communication with the platform, which then sends a remote command to the cameras and microphones to begin livestreaming and recording and starts the timer. Upon expiration of a time period, the timer is operable to cause the cameras and microphones in the interior of the audition apparatus to stop live streaming and/or stop recording, either via direct wireless communication or via communication through the platform. In another embodiment, the cameras and microphones record a separate session after expiration of the time period to capture a contestant's reaction to their performance. The time period on the timer is customizable, and is set depending on the rules for a contest. In one embodiment, the cameras are pan-tilt-zoom (PTZ) cameras which are remotely controlled by an operator. The microphones preferably include one or more microphones operable to capture ambient sound in the audition apparatus and at least one microphone for each instrument or vocals. The microphones and cameras are preferably plugged into a decoder operable to send Internet Protocol (IP) video to a wireless (ex: WIFI) or ethernet device connected to a digital capture device and/or television control room or studio. Communication and commands sent to the audition apparatus are preferably sent over a Virtual Private Network (VPN) to a local computing device of the audition apparatus or to pieces of equipment directly to ensure that the communication between the platform and equipment in the audition apparatus is secure, including control of the cameras, microphones, and other equipment in the audition apparatus.

In one embodiment, once the at least one audition apparatus is unlocked and activated for a user, the at least one audition apparatus remains unlocked and the equipment remains activated for a predetermined time period measured by a timer in network communication with the platform of the present invention. Alternatively, the at least one audition apparatus remains unlocked and activated as long as the user device is within the at least one audition apparatus or within a predetermined proximity of the at least one audition apparatus, such as within twenty-five (25) meters of the at least one audition apparatus. Proximity of the user device to the at least one audition apparatus is determined in one embodiment via geofencing, Global Positioning System (GPS), cellular triangulation, or wireless communication between the user device and a computing device associated with the at least one audition apparatus. In another embodiment, the audition apparatus is automatically locked after the contestant enters the audition apparatus so that the contestant is not disturbed during their audition. An administrator account is operable to unlock the audition apparatus remotely in the event of an emergency, such as a health emergency of the contestant, or a contestant refusing to leave the audition apparatus, with the remote unlocking of the audition apparatus providing access for emergency personnel such as police and first responders to enter the audition apparatus. In another embodiment, a contestant or performer receives a predetermined number of chances or auditions in the audition apparatus, or has an allotted time to produce media content such as audio or video content, and the door is automatically locked after the contestant or performer leaves the audition apparatus after the contestant or performer has used their number of chances or auditions or exhausted their allotted time.

The equipment in the at least one audition apparatus is operable to be activated for a predetermined time period without user device presence and without the receipt of the at least one code by the at least one identity verification device of the at least one audition apparatus, such that the equipment is activated a short time period (such as 1 hour) before the audition apparatus is eligible to be unlocked via the at least one code. This enables a connection to be established between a computing device of the at least one audition apparatus and the platform ahead of a recording session, and enables for the status of the equipment to be evaluated remotely via the platform in real time or near real time such that any issues with the equipment are operable to be addressed before the user session. Each recording is identified with a unique code or symbol, and is associated with the unique identifier associated with the user account of the contestant or performer. In one embodiment, the unique code or symbol used to identify each recording is the same code utilized to grant access to the audition apparatus. In the event that multiple performers or contestants perform a piece together, a separate group code is assigned to each audio and/or video file associated with those performers or contestants in the platform.

In one embodiment, the audition apparatus includes windows which are transparent when the audition apparatus is not actively recording audio and/or video. Upon activation of the equipment for recording, such as via activation of a start button, the windows to become opaque to provide privacy for a contestant recording inside the audition apparatus. In one embodiment, transition of the windows from transparent to opaque is accomplished via use of “smart glass” which is operable to change from transparent to opaque upon application of an electric field. One example of this technology is described in U.S. Pat. No. 10,895,736, which is incorporated herein by reference in its entirety. Alternatively, smart curtains or smart blinds are utilized to provide privacy for the contestant, with the beginning of a recording session causing the smart curtains or smart blinds to automatically close and the ending of a recording session causing the smart curtains or smart blinds to automatically open. In one embodiment, the smart curtains or smart blinds are an Internet of Things (IoT) device in communication with the local computing device of the audition apparatus or in communication with the platform of the present invention. In an alternative embodiment, equipment is activated and recording begins upon detection of movement and/or sound in the interior of the audition apparatus; smart windows, curtains, or blinds are also activated upon detection of movement and/or sound in the interior of the audition apparatus to provide the contestant privacy.

Advantageously, the present invention provides timestamps for each section of audio and/or video content to provide for synchronization of audio and/or video content from different equipment or from different audition apparatuses which is received by the platform at different times but which should be presented together. Each timestamp is applied at the time the raw content is received by the audio or video input device or a local computing device including a processor and a memory associated with the audio or video input device, such that if there is a delay in transmission of audio or video content captured in the audition apparatus, the platform is operable to synchronize the audio and video content based on the timestamps of the audio and video content. The present invention also provides for recording audio and video content from multiple audition apparatuses, providing timestamps for the audio and video content when the content is received by the associated audio or video input devices or local computing devices associated with the audio or video input devices. The platform is then operable to synchronize the audio and/or video content in real time or near real time and create one or more edited audio or video presentations or files which include content synchronized based on the timestamps from multiple audition apparatuses. The raw content is automatically transmitted via wireless network-based communication to the platform, which is located remote from the apparatus housing, for processing into an edited content and/or for storage in at least one database. Alternatively, the audio and/or video captured by the equipment is transmitted in real time or near real time over wireless or wired network-based communication to a local computing device such as an edge device for local storage, and then is transmitted to the remote platform.

In one embodiment, the raw data or edited data, including media content such as video or audio content, is processed by the platform for generating an automated rating or scoring of the raw content. Rating or scoring factors for audio content include pitch, tone, tempo, timing, pronunciation, accents, vibrato, volume, playing technique, dynamics, correct notes or chords, recovery from mistakes, originality, accuracy, synchronization between multiple instruments such as guitar and drums or guitar and vocals, or any other quantifiable attribute operable to be recorded by the equipment in the audition apparatus, sent to the platform, and analyzed by a scoring module of the platform. Rating or scoring factors for video content include facial expressions, posture, appearance, dress style, intonation, body language, or any other quantifiable attribute operable to be recorded by the equipment in the audition apparatus, sent to the platform, and analyzed by a scoring module of the platform. In one embodiment, the scoring module of the present invention includes an artificial intelligence module or machine learning module which provides the rating or score based on the scoring factors. Different genres or audio and video are evaluated based on different scoring or rating criteria.

A score or rating above a certain threshold provides access to another track, script, composition, or other document or piece of media in one embodiment. This embodiment is advantageous in scenarios in which obtaining a predetermined score on a first audition is required to advance to a second audition. For example, in an audition for a band, a minimum score of 80 out of 100 for a playing exercise or track is required to advance from a first audition to a second auction. In another embodiment, receiving a grade of a B+ on a first script is required to provide access to a second script. Thus, the present invention provides for automated screening of performers in initial rounds before providing media content to judge devices for manual scoring or evaluation. In one alternative embodiment of the systems and methods of the present invention, if the raw content is rated or scored above a predetermined threshold after a session and after equipment has been deactivated in the audition apparatus, then the platform automatically generates a second code that is transmitted to the mobile computing device of the user and/or to the audition apparatus and equipment enclosed therein to provide a second activation of the equipment for a second capture session of second raw content including audio and/or video input that is associated with the second code. The second raw video is transmitted to the platform for processing, editing and/or storage in the database.

The at least one code providing for access and activation of the equipment is preferably activated for a predetermined time period based upon a format, a type of show, a type of performance, or combination thereof. Advantageously, the present invention provides for different codes to be associated with activation of different equipment. For example, a code associated with an audio recording session activates audio equipment but does not activate video equipment. Alternatively, a code associated with an audition for a television show or movie activates both audio and video equipment. In another embodiment, the activation of the equipment is provided by the platform generating a message to the housing apparatus receiving unit and electronic switching mechanism to activate and/or deactivate the equipment remotely from the housing apparatus. In one embodiment, equipment is automatically powered off or recording on the equipment is disabled when the code providing for entry into the audition apparatus is deactivated, or a predetermined time period after the code providing for entry into the audition apparatus is deactivated.

Additionally, different codes are associated with different account or user levels and corresponding permissions for the audition apparatus. In one embodiment, a contestant or performer code grants access to the audition apparatus for a predetermined date and a predetermined time period, and the equipment within the audition apparatus necessary for recording a performance or audition for that predetermined date and predetermined time period, but does not grant access to change settings of equipment within the audition apparatus. An administrator code grants access to the audition apparatus at any time and provides access to change settings of equipment within the audition apparatus. Each code is associated with an account registered with a software application, a web page, or another account such as an email account or user account of a mobile device (e.g., an APPLE account, an ANDROID account, etc.). In one embodiment, an account is created automatically along with the code and is sent to the recipient via email, text message such as Short Message Service (SMS) or Multimedia Message Service (MIMS), or any other method of electronic communication known in the art. Accounts of the present invention include a profile, a user name, a photo, contact information such as a mobile phone number, an email address, one or more payment methods, and/or an account type (administrator, performer, etc.). The profile is associated with all unique codes that have been assigned to the account, such that there is a record of each code which has been assigned to the account. In one embodiment, the unique codes are recorded on an immutable ledger, such as the blockchain or a hashgraph. The ledger is preferably updated in real time or near real time as a code is assigned to an account and as each code is utilized to access an audition apparatus, including the code, the account, an identifier of the audition apparatus, and a date and time associated with the assignment of the code and thereby providing an immutable record of which accounts have accessed which audition apparatuses.

The equipment inside the audition apparatus includes, by way of example and not limitation, a microphone, a camera, headphones, cables, one or more microphone stands, at least one pop filter, a computer including a recording device, one or more display devices associated with one or more computers, a digital audio workstation connected to the computer, a device operable to receive digital files such as MPEG-1 Audio Layer-3 (MP3) files or Free Lossless Audio Codec (FLAC) files via an input device (Universal Serial Bus (USB) port, compact disc (CD) reader, etc.) connected to the computer, a seating apparatus such as a chair, a bench, or a stool, and studio monitors or speakers. The audition apparatus is operable to include lockers or equivalent apparatuses for securing equipment or selected instruments. In one example, selected instruments include guitars, bass guitars, woodwind instruments, brass instruments, drum sets, keyboards, or any other instrument known in the art. In one embodiment, the lockers are operable to be unlocked via the same code which is used to obtain entry into the audition apparatus. Alternatively, another method is utilized to unlock the lockers, such as a device including a camera connected to a processor and a memory connected to a locking mechanism of a locker providing facial recognition of a user or another form of secondary authentication as described herein or known in the art and unlocking the locker upon authenticating the user or user device. The equipment includes radio frequency identification (RFID) tags in one embodiment, which are in communication with a RFID reader on the door of the locker, such that if any equipment in the audition apparatus is removed from the locker, the RFID reader sends a communication to a local computing device associated with the audition apparatus or a communication to the platform, and the removal of the RFID tag and corresponding piece of equipment is logged. In one embodiment, the removal of the RFID tag and corresponding piece of equipment is recorded on a distributed ledger such as the blockchain or a hashgraph.

In scenarios where a performer is performing a piece of media with other performers, a local computing device provides audio output via headphones or speakers which is received from the platform of other performances in real time or near real time, such that multiple musicians are operable to play a song together and actors are operable to engage in a dialogue from multiple audition apparatuses despite being in multiple geographic locations. Additionally, the one or more display devices provide for viewing the interior of other audition apparatuses to view co-performers or competitors, or provide for viewing of judges, producers, interviewers/interviewees, one or more audience members, or any other party relevant to an audition or performance. Communication with these parties occurs before, during, or after the audition. Preferably, headphones are utilized by the contestant to aid in monitoring their performance in real-time and to aid in communication with other parties via an interruptible foldback (IFB) or similar system. The display apparatus is also operable to display content relevant to a performance, such as lyrics, a script, sheet music, and/or tablature. The digital audio workstation connected to the computer preferably includes recording software and digital instrument accompaniment selection or selections for song or instrumental accompaniment. In one embodiment, the digital audio workstation connected to the computer includes a selection mechanism for selecting an instrument to accompany a performer and/or a song selection mechanism for selecting a song or track to accompany from a song or track library. The digital audio workstation connected to the computer is also operable to change the key of pre-recorded tracks or songs, and is operable to change the key of audio content recorded in the audition apparatus. Alternatively or additionally, the platform is operable to change the key of audio content recorded in the audition apparatus.

Preferably, each piece of electronic equipment includes a unique identifier and is operable to be remotely controlled through the platform via a local computing device present at the audition apparatus, such as an edge device or a computer including a processor and a memory located within the audition apparatus. As described above with respect to equipment and/or instruments in lockers of the audition apparatus, the equipment also includes radio frequency identification (RFID) tags in one embodiment which are operable for communication with a RFID reader at the exit of the audition apparatus, such that if any equipment in the audition apparatus is removed from the audition apparatus, an alarm of the audition apparatus is activated and an administrator account of the platform and/or law enforcement receives an alert. The alarm is also operable to produce visual and/or audio output within the audition apparatus and external to the audition apparatus to deter theft.

In one embodiment, the equipment includes multiple cameras, such as three cameras, which record a performer or contestant from different angles, with the platform including a video selection module operable to select different views of the contestant or performer at different points in time for transmission to the platform in real time or near real-time, with the platform being operable to assemble a livestream of the contestant or performer from the different video feeds from the different cameras. Advantageously, the cameras of the present invention or local computing devices associated with the cameras are operable to timestamp video content and the platform is operable to synchronize the video content based on the timestamps to create an edited video which includes video from multiple cameras. In one embodiment, the edited video includes a picture in picture view, with the smaller video showing a close up of a certain contestant or performer or a certain part of the body of the contestant or performer, optionally in contact with an instrument, such as one or more hands of a guitar player on a fretboard and/or the strings of the guitar. In embodiments in which multiple contestants or performers are present in the audition apparatus, the platform is operable to analyze audio and video data and create an edited video in real time or near real time with different views of performers based on audio and/or video data. An artificial intelligence module of the platform is operable to rate video from each camera with a score based on scoring factors for the audio or video and/or on a contribution of one or more performers being more significant at a point in time than the contributions of other performers, such as a guitar solo, a drum solo, a vocal solo, a bass solo, etc. In one embodiment, the platform is operable to send a command to a camera with zoom functionality to zoom in on a particular performer or instrument based on a score provided by the platform in real-time for video associated with that camera. The platform is operable to maintain a score for video from each of the cameras in real time or near real time and switch between content captured by different video cameras in real time or near real time when creating an edited video based on the scores. In one embodiment, scores range from 0 to 100, and in order for a second video clip from a second camera to be displayed as opposed to a first video clip from a first camera, the second video clip score must surpass the score of the first video clip by a predetermined threshold, such as by 5 points, by 10 points, etc. This advantageously prevents minor changes in scores from creating a situation where the video displayed from different cameras changes rapidly, creating an incoherent video and confusing an audience.

Lighting equipment is provided in the audition apparatus in one embodiment. The lighting equipment is operable to be controlled locally by a local computing device within the audition apparatus or remotely via the platform. Adjustable settings for lighting equipment include locations of the lighting components (e.g., lighting components are provided on a track and are operable to be adjusted via motors connected to the track), brightness of lighting components, color of light emitted by lighting components, and any other setting for lighting known in the art.

Video equipment includes a green screen or a blue screen in one embodiment. The background for the green screen or blue screen is operable to be changed in real-time via a command from the platform which is sent to a local computing device associated with the audition apparatus, or via a local computing device located within the audition apparatus. In another embodiment, a device associated with the performer or contestant which unlocked the audition apparatus is operable to change the background of the blue screen or green screen in real-time, with a display device in the audition apparatus being able to display video from one or more cameras showing the background on the blue screen or the green screen. This is particularly advantageous in creating a desired environment during interviews, and the audition apparatus is operable to be used for professional interviews such as television interviews or job interviews. Alternatively, a performer or administrator account of the platform is operable to create a desired background during a performance, such as a certain location for a movie audition or certain visual effects during a performance of a song. In situations in which performers perform together or engage in a dialogue, the platform of the present invention is operable to combine video and audio recordings from multiple audition apparatuses to provide a single integrated video and audio file and presentation. The audition apparatuses and platform of the present invention enables incorporation of multiple performers or contestants into a single raw video file, and use of the green screen or blue screen provides for an edited video file to be produced with a background which enhances the perception that the multiple performers or contestants are in the same location performing together, although video and/or audio is recorded at different, remote audition apparatuses. In another embodiment, one or more light emitting diode (LED) video walls are utilized instead of a green screen or a blue screen, with the LED video walls also providing for customizable backgrounds in real time or near real time.

The audio and/or video capture or recording transmitted to the platform is preferably stored in at least one database for editing the raw content, adding new content, and/or integrating the raw content within a formatted content for a final audio and/or video content, such as a television show, including one or more raw content inputs associated with their corresponding at least one code and corresponding at least one user account. In the example of the television show, programmed content including audio and/or video inputs from the raw video from the mobile housing and equipment operable therein is provided. In one embodiment, the audio and/or video content is transmitted to the platform, which then transmits the audio and/or video content in real time or near real time to an audio or video server, edge device, or a cloud environment, thereby providing for real-time or near real-time consumption of the audio and/or video content by a plurality of devices associated with viewers or judges.

For edited audio and/or video content, the platform provides for automated editing of audio content, including but not limited to adjusting gain, keyframing levels, tone, crossfades, panning, fading in or out, normalization, equalization, amplification, compression, limiting, noise removal, or slicing of individual clips from multiple audio files. In another embodiment, automated audio editing includes providing a backing track or a track from another instrument. By way of example, an instrumental track is operable to be added to a vocal track recorded in the audition apparatus. In this way, the present invention provides for a karaoke mode in which one or more performers in one or more audition boxes are operable to sing along with an instrumental track, with the performance being streamed in real time or near real time or recorded. Alternatively, a drum machine track is operable to be added to a guitar track and/or a vocal track by the platform of the present invention. An audio filter or signal processing is also operable to be applied to the audio track, including by way of example and not limitation, Butterworth filters, Chebyshev filters, Bessel filters, Elliptic filters, Optimum “L” filters, Gaussian filters, and Raised-cosine filters.

Automated editing of video content provided by the platform includes cutaway shots, cuts, adjustments to hue, saturation, brightness, and contrast, or any other video editing techniques known in the art. In another embodiment, filters such as SNAPCHAT filters are operable to be applied to the video content when received by the platform or locally at the camera or device connected to the camera in the audition apparatus. Preferably, the audio and/or video content is stored locally on an edge device associated with the audition apparatus, and is deleted from the edge device within a predetermined time after the audio and/or video content is sent to the platform and the platform sends a confirmation message to the edge device indicating that the platform has received and stored the audio and/or video content.

A plurality of audience or judge devices are operable to display raw or edited audio and/or video content produced in the audition apparatus via at least one software application, at least one website, at least one holographic rendering, and/or at least one virtual reality or augmented reality environment. In one embodiment, the plurality of devices associated with viewers or judges are operable to send real-time or near real-time feedback to the platform via feedback controls on the device, such as feedback controls provided by a software application or the at least one website. This feedback is operable to be displayed on a display within the audition apparatus in real-time or near real-time in one embodiment. Feedback includes textual feedback such as comments, requests, ratings, etc., image feedback such as emojis, thumbs up, thumbs down, or any other type of feedback known in the art. Devices associated with viewers or judges are operable to view video or images from the interior of multiple audition apparatuses or receive audio from multiple audition apparatuses simultaneously in one embodiment, such as when multiple people perform a song together or engage in a dialogue. In another embodiment, devices associated with viewers or judges are operable to view video or images from the interior of multiple audition apparatuses or receive audio from multiple audition apparatuses in series, such as when multiple contestants compete against each other in an audial and/or audial and visual competition.

In one embodiment, the platform includes an algorithm to weight feedback from different user devices. For example, judge feedback constitutes 70% of a score for a contestant, and viewer feedback constitutes 30% of a score for a contestant. Additionally, different viewer feedback is weighted differently depending on whether the account on the device associated with the viewer is associated with a paid subscription or if the account on the device associated with the viewer has achieved a status such as a super fan status, in which case the feedback from these accounts is given a greater weight in calculating an overall feedback score than accounts that have not achieved such a status or accounts which are unpaid.

In another embodiment, feedback includes tips or suggestions for a performer, such as a suggested improvement to a technique, other suggested styles of music, acting, or performance which are suitable for a performer based on an analysis of a performance. For example, a performer having a soft voice performs a hard rock song, and a suggestion is sent to the performer to try a country song or soft rock song. In one embodiment, the suggestion includes a specific song or artist. Advantageously, these tips or suggestions are operable to be automatically generated by the platform or are provided via the scoring module of the platform of the present invention.

In one exemplary embodiment, one or more audition apparatuses is utilized in conjunction with an audition television show or web show, with the episodes of the television show or web show including audio and video content form one or more audition sessions from the one or more audition apparatuses. In this exemplary embodiment, the show is directed to finding the next country music stars. Accounts associated with contestants are provided with a code which grants access to one or more audition apparatuses at a predetermined date and time. The code is sent to an existing email account or via SMS or MMS messaging to a mobile phone or mobile device in one embodiment. The code is associated with an account registered with the platform, such that all recordings made within the audition apparatus are associated with the account registered with the platform in a platform database, cloud storage associated with the platform, or any other device associated with the platform. In the case of multiple performers or contestants performing together or competing against each other, multiple codes are operable to be associated with each other in a platform database, such as a database on a remote server computer or a cloud computing database. Additionally, multiple codes associated with the same account, such as codes associated with different dates and times of access for the same account or device, are operable to be associated with each other in a platform database, such as a database on a remote server computer or a cloud computing database.

At the predetermined date and time, an identity verification device of the audition apparatus receives the code as an input, sends an access request to a local computing device associated with the audition apparatus or to a platform device, and provides access to the interior of the audition apparatus upon receiving an access authorization message from the local computing device or the platform device. Alternatively, the identity verification device includes a memory which is updated periodically or in real time or near real time by the platform with codes and dates/times during which the codes are operable to provide access to the audition apparatus. The equipment within the audition apparatus is also activated upon the identity verification device providing access to the audition apparatus, or alternatively has been previously activated at a predetermined date and time and provides recording functionality upon the identity verification device providing access to the audition apparatus. The contestant performs one or more songs or other media or multimedia performance pieces, with each input captured by the equipment being timestamped and sent to the platform. The platform provides for editing the video and/or audio content in real time, enabling the performance or audition to be broadcast or transmitted in real time or near real-time to a multiplicity of viewer and/or judge devices. In one embodiment, the broadcast includes an intentional delay between the time the platform receives the audio and/or video content and the time that the audio and/or video content is broadcasted to allow for review of the content for inappropriate or offensive content such that any inappropriate or offensive content is operable to be removed from the audio and/or video content before broadcasting the content. If the audition or performance is recorded for later presentation, the platform provides for automated editing of the audio and/or video content using any audio or video editing technique described herein. Judge devices and viewer devices vote or provide feedback on the performance in real time or near real time. If the audition is broadcast live or in near real time, a device including a display within the audition apparatus is operable to display feedback to the performer or contestant in real-time or near real-time. Thus, the audition apparatus and platform of the present invention provide for multiple contestants to perform on a television show or web show and for their performance to be broadcast in real time or near real time, regardless of location, so long as the audition apparatus in which the contestant is performing is connected to the platform via a wireless network. Additionally, if multiple contestants perform a song together, the platform is operable to utilize timestamps from the audio and/or video content to ensure that the audio and/or video content is synchronized when transmitted to viewer or judge devices.

In another exemplary embodiment, performers are auditioning for a role in a recorded television show or a movie. Multiple performers are operable to unlock their respective audition apparatuses using unique codes, and audio and video equipment within the audition apparatuses is activated. Display devices within each audition apparatus are operable to display the interior of other audition apparatuses, such that each performer is operable to view other performers in real time or near real time. Additionally, one or more audio output devices, such as headphones or speakers, are operable to provide audio from other audition apparatuses to an audition apparatus to enable dialogue between the performer in the audition apparatus and the other audition apparatuses. The audition apparatuses all include a blue screen or a green screen, and an administrator selects a background for the performers or contestants and combines video and audio from the multiple audition apparatuses into a single edited multimedia file so that the performers appear together in the same video file. This enables judge accounts to view performers together and evaluate their combined performance more easily, in addition to evaluating each performer's individual performance. Each audio and video recording or file is associated with the respective performer's unique code in a platform database, and is also associated with a group code which is used for any audio or video file associated with the group of performers.

In yet another embodiment, an interviewer and an interviewee utilize separate audition apparatuses. Each party unlocks their respective audition apparatus with their unique code, and the appropriate equipment is powered on or activated for use by the interviewer and interviewee. The interviewer audition apparatus includes a display device and audio output device operable to provide video and audio output from the interviewee audition apparatus. Likewise, the interviewee audition apparatus includes a display device and audio output device operable to provide video and audio output from the interviewer audition apparatus. Both the interviewer and interviewee audition apparatuses include a green screen or a blue screen, and a device operable to select a background for the interviewer and interviewee. The interviewer and interviewee edited videos preferably include different backgrounds, or are edited such that the interviewer and interviewee videos are merged together with the same background and the interviewer and interviewee appear to be in the same location.

Other uses for the audition apparatus of the present invention include a gaming environment, a photography studio, a production studio for short clips such as TIKTOK videos, podcasts, or any other application in which audio, video, and/or imaging equipment is utilized to create content.

In one embodiment, the audition apparatus is operable for rent on an as needed basis. The platform maintains a schedule for each audition apparatus. Accounts registered with the platform are operable to view openings in the schedule and reserve an audition apparatus if the audition apparatus is available by selecting an available date and time for the audition apparatus and providing payment for that date and time using at least one payment method. A code providing access to the audition apparatus is then sent to the account such that the user is operable to access the audition apparatus via the code at the predetermined date and time and for a predetermined duration. In one embodiment, the audition apparatus includes a visual indicator of availability of the audition apparatus for use, such as via a green light if the audition apparatus is available for rent, or a red light if the audition apparatus is not available for rent. This visual indicator provides a notification of availability of the audition apparatus for people passing by the audition apparatus and an indication of the opportunity to rent the audition apparatus through the platform.

Location data is created in the present invention using one or more hardware and/or software components. By way of example and not limitation, location data is created using the Global Positioning System (GPS), low energy BLUETOOTH based systems such as beacons, wireless networks such as WIFI, Radio Frequency (RF) including RF Identification (RFID), Near Field Communication (NFC), magnetic positioning, and/or cellular triangulation. By way of example, location data is determined via an Internet Protocol (IP) address of a device connected to a wireless network. A wireless router is also operable to determine identities of devices connected to the wireless network through the router, and thus is operable to determine the locations of these devices through their presence in the connection range of the wireless router.

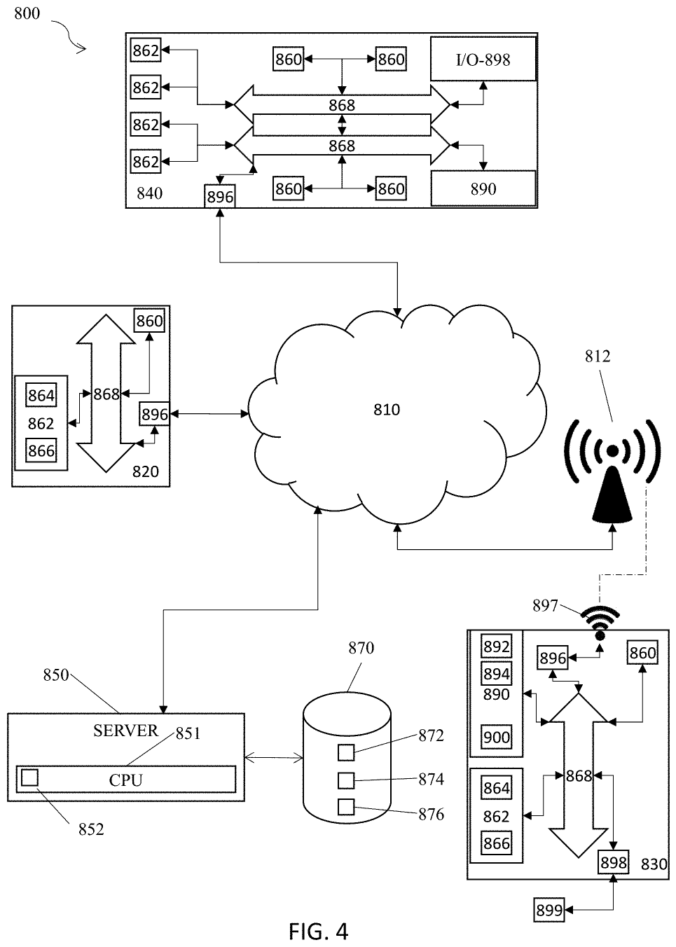

FIG. 4 is a schematic diagram of an embodiment of the invention illustrating a computer system, generally described as 800, having a network 810, a plurality of computing devices 820, 830, 840, a server 850, and a database 870. Each device referred to in the present specification is operable to have the characteristics of the plurality of computing devices 820, 830, 840 discussed with respect to this figure, as well as a processor, a memory, and a wireless or wired communications interface for communicating with other devices over a network.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 4, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 4, is operable to include other components that are not explicitly shown in FIG. 4, or is operable to utilize an architecture completely different than that shown in FIG. 4. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A system for recording multimedia content comprising:
an apparatus for recording the multimedia content including a housing, a microphone, a camera, one or more power sources for providing power to the camera and/or the microphone, and an identity authentication device; and
a platform device including a processor;
wherein the housing includes the microphone and the camera within the housing;
wherein the housing includes at least one wall and a door;
wherein the housing is approximately eight feet in width or approximately eight feet in diameter;
wherein the apparatus is constructed and configured for communication with the platform device via at least one local device including at least a processor;
wherein the identity authentication device is configured to unlock the apparatus upon verifying that a user or a user device is authorized to access the apparatus;
wherein the microphone and the camera are configured to record audio content and video content;
wherein the audio content and the video content is timestamped with timestamps indicating the time that the audio content and the video content was recorded; and
wherein the audio content and the video content and the timestamps are transmitted to the platform device.

2. The system of claim 1, wherein the microphone and the camera are configured to begin simultaneously recording the audio content and the video content upon activation of a single virtual recording button, upon activation of a single physical recording button, upon a voice command, upon a command received through the platform device, or upon unlocking of the apparatus.

3. The system of claim 1, wherein the identity authentication device is configured to unlock the apparatus upon verifying that the user or the user device is authorized to access the apparatus by reading and verifying biometric information associated with the user or upon receiving a code from the user or the user device.

4. The system of claim 1, wherein the platform device is configured to receive audio content and video content from at least one other apparatus, wherein the audio content and the video content from the at least one other apparatus is timestamped with timestamps representing the time that the audio content and the video content was recorded at the at least one other apparatus, and wherein the platform device is configured to synchronize the audio content and the video content from the apparatus with the audio content and the video content from the at least one other apparatus to create integrated audio content and integrated video content.

5. The system of claim 1, wherein the audio content and the video content is configured to be streamed to at least one display device including a display and a speaker in real time or near real time.

6. The system of claim 5, wherein a plurality of voting devices are configured to provide feedback on the audio content and the video content in real time or near real time, wherein the feedback on the audio content and the video content is aggregated and displayed on the display device in real time or near real time.

7. The system of claim 1, wherein the apparatus is a mobile apparatus, wherein the mobile apparatus includes a plurality of wheels, wherein the plurality of wheels are configured to be locked so that the mobile apparatus does not move via the plurality of wheels and wherein the plurality of wheels are configured to be unlocked to move the mobile apparatus via the plurality of wheels.

8. The system of claim 1, wherein the housing of the apparatus includes weather resistant materials, ruggedized materials, waterproof materials, or water resistant materials.

9. The system of claim 1, wherein the apparatus includes an exterior camera including a camera microphone, wherein the exterior camera is configured to capture video and audio of the user outside the apparatus.

10. The system of claim 1, wherein the apparatus further includes at least one musical instrument inside the housing of the apparatus.

11. The system of claim 1, wherein the microphone and the camera include tags configured to provide location data for the microphone and the camera, wherein an alert is sent to the platform device if the microphone and/or the camera is determined to be outside the housing of the apparatus.

12. The system of claim 1, wherein the user, the user device, the audio content, and the video content are associated with a unique code, wherein the audio content and the video content are stored on the platform device with the unique code.

13. The system of claim 1, wherein the audio content apparatus further comprises a speaker, wherein an accompanying audio track is configured to be played by the speaker while the microphone and the camera record the audio content and the video content.

14. The system of claim 1, wherein additional audio content and/or additional video content is configured to be integrated with the audio content and the video content in real time or near real time, and wherein the integrated audio content and the integrated video content is configured to be played on a display device including a display and a speaker in real time or near real time.

15. The system of claim 1, wherein the audio content and/or the video content is configured to be automatically edited in real time or near real time by the platform device, wherein the automatic editing of the audio content and/or the video content includes adjustments to hue, saturation, brightness, and/or contrast, adjustments to gain and/or tone, normalization, equalization, amplification, compression, application of one or more filters, and/or noise removal.

16. A system for recording multimedia content comprising:
an apparatus for recording the multimedia content including a housing, a microphone, a camera, one or more power sources for providing power to the camera and/or the microphone, and an identity verification device; and
a platform device including a processor;
wherein the apparatus is constructed and configured for communication with the platform device;
wherein the identity authentication device is configured to unlock the apparatus upon verifying that a user or a user device is authorized to access the apparatus;
wherein the microphone and the camera are configured to record audio content and video content;
wherein the audio content and the video content is configured to be streamed to at least one display device including a display and a speaker in real time or near real time; and
wherein the audio content and/or the video content is configured to be automatically edited by the platform device in real time or near real time, wherein the automatic editing of the audio content and/or the video content includes adjustments to hue, saturation, brightness, and/or contrast, adjustments to gain and/or tone, normalization, equalization, amplification, compression, application of one or more filters, and/or noise removal.

17. The system of claim 16, wherein a plurality of voting devices are configured to provide feedback on the audio content and the video content in real time or near real time, wherein the feedback on the audio content and the video content is aggregated and displayed on the at least one display device in real time or near real time.

18. The system of claim 16, wherein additional audio content and/or additional video content is configured to be integrated with the audio content and the video content in real time or near real time, and wherein the integrated audio content and the integrated video content is configured to be played on the at least one display device in real time or near real time.

19. A system for recording multimedia content comprising:
an apparatus for recording the multimedia content including a housing, a microphone, a camera, and one or more power sources for providing power to the camera and/or the microphone; and
a platform device including a processor;
wherein the apparatus is constructed and configured for communication with the platform device;
wherein the microphone and the camera are configured to record audio content and video content; and
wherein additional audio content and/or additional video content is configured to be integrated with the audio content and the video content in real time or near real time, and wherein the integrated audio content and the integrated video content is configured to be played on a display device including a display and a speaker in real time or near real time.

20. The system of claim 19, wherein the additional audio content is an instrumental audio track.
